(19) United States
(12) Patent Application Publication
(10) Pub. No.: US 2013/0141226 A1
(43) Pub. Date: Jun. 6, 2013

(54) Automobile Telemetry for Data, Text, and Video Communication

(71) Applicant: Brooks Alexander Agnew, Concord, NC (US)

(72) Inventor: Brooks Alexander Agnew, Concord, NC (US)

(21) Appl. No.: 13/682,957

(22) Filed: Nov. 21, 2012

Related U.S. Application Data
(60) Provisional application No. 61/565,548, filed on Dec. 1, 2011.

(51) Int. Cl. B60Q 11/00

(52) U.S. Cl. CPC B60Q 11/00
USPC 340/425.5

(57) ABSTRACT

The present invention comprises an automobile instrument display comprised of electronic hardware and software, with the display having a graphical user interface which is a screen located in place of at least one of an instrument on an instrument panel of a vehicle which is required for normal vehicle operation. The present invention also comprises an automobile-based electronic receiver and display that allows graphic or text information to be received and displayed to the operator of an automobile. The present invention also comprises an automobile-based data output device having a display capable of displaying to the operator of the automobile scalable electronic information that is downloaded into or transmitted to the automobile.

### CROSS REFERENCE TO RELATED APPLICATIONS

The present application claims the priority of U.S. provisional application No. 61/565548, filed on Dec. 1, 2011, which is herein incorporated by reference.

### BACKGROUND OF THE INVENTION

1. Field of the Invention

This invention relates to the technical field of automobile instrumentation. More particularly, the present invention is in the technical field of automobile electronic displays using a graphical user interface. More particularly, the present in invention is in the technical field of electronic commerce. More particularly, the present invention is in the technical field of wireless electronic communication.

2. Description of Related Art

A description of prior art would be the electronic graphical user interface utilized by navigation and entertainment controls and displays in an automobile. Review of the relevant literature reveals that there exists a need for wireless electronic communication methods and systems that include the provision of a visual graphical communication with the operator from an outside resource.

### BRIEF SUMMARY OF THE INVENTION

The present invention provides an electronic graphical user interface that wirelessly receives electronic information from an outside resource and displays that electronic information to the occupants of an automobile. More particularly, the present invention is an electronic graphical user interface that wirelessly receives and displays electronic information to the occupants of an electric automobile. A feature of the present invention is the information of the connection of the automobile's electronic display to a sender of electronic information via wireless communication. More particularly, a feature of the present invention is the information may be in the form of electronic commerce. More particularly, the electronic information may be geographically pertinent to the target audience of the sender(s). More particularly, a feature of the present invention is the electronic information may be displayed immediately after the vehicle is energized by the driver before the vehicle is able to move. This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a perspective view of a typical graphical user interface representation of the present invention as the driver's instrument panel;

FIG. 2 is a side view of the driver's graphical user interface instrument panel;

FIG. 3 is a top view of the driver's graphical user interface instrument panel; and

FIG. 4 is a perspective view of the driver's graphical user interface instrument panel of the present invention.

### DETAILED DESCRIPTION OF THE INVENTION

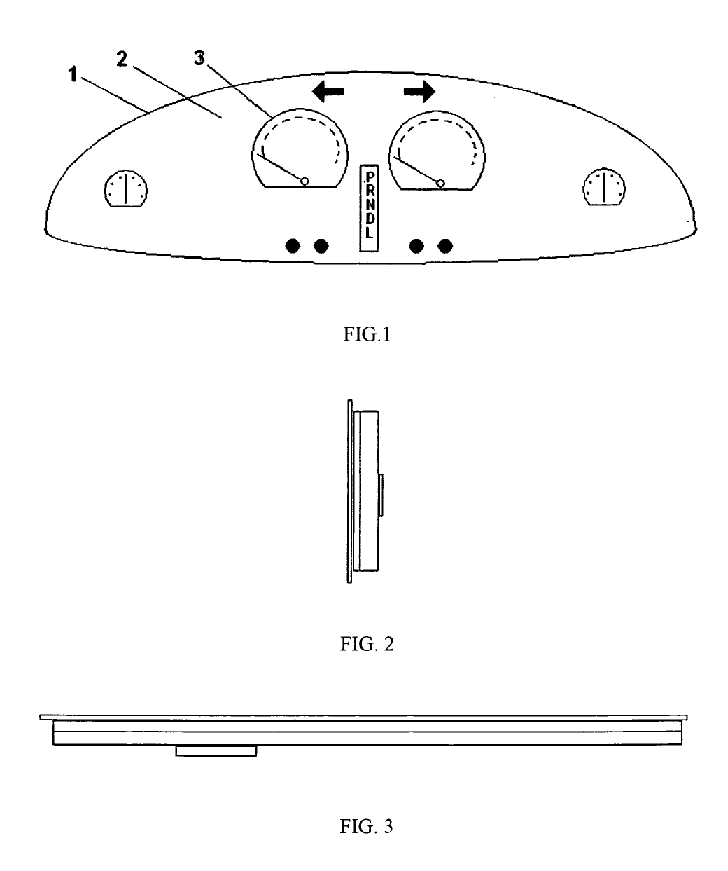

Referring now to the invention in more detail, in FIG. 1 there is shown a Liquid Crystal Display or a Plasma Screen Display (2), being trimmed by a shaped bezel (1) forming an integral instrument panel. The hardware facilitates the electronic display of the instrumental interface between the vehicle and the driver. Those familiar with the art know that there is a typical electronic booting period where the electronics and the computer processor are performing diagnostics and ensuring that all the internal power supplies are within acceptable parameters. The display then switches to the instrumental indicators (3) that show the operator various parameters of the vehicle. Further, those familiar with the art have noticed similar graphical user interfaces displaying the company logo and various text messages that are non value-added to the operation of the vehicle or to the driving experience of the driver in auxiliary displays in a motor vehicle such as GPS, or entertainment center interfaces. These displays are typically repetitive and non-updatable, because the components are not capable of telemetric, wireless, or electronic communication with electronic sources outside the vehicle. It is a feature of the present invention to form a cellular phone connection between the vehicle instrumentation and display, and an outside electronic resource. That outside resource would then be capable of downloading electronic information into the electronic storage device of the vehicle. The Proposed Invention makes use of the Liquid Crystal Display or Plasma Screen Display as an advertising display.

Still in more detail, a feature of the present invention is the use of the Liquid Crystal Display or Plasma Screen Display (2) as a media interface for graphical electronic information that is in addition to, or in lieu of, the instruments that those familiar with the art would see if they were operating the vehicle.

Still in more detail, a feature of the present invention is to use the instrument display panel in the vehicle for visual presentations to the operator prior to the motion operation of the vehicle. This might be in the form of alerts, advertisements, updates and hints from the factory, and other time-sensitive information that originates with the factory, or its assigns.

Referring now to the invention in more detail, in FIG. 2 there is a side view of a typical Liquid Crystal Display or Plasma Screen Display that is thin enough to fit behind the bezel of the instrument panel, facing the driver of the vehicle. Under normal motivated operation of the vehicle, the display contains the typical instruments that a driver would require for feedback about the operation of the vehicle. It is a feature of the invention that this thin-profile electronic circuitry can act like an electronic interface that displays information about local events, emergency alerts, and other information that may be downloaded to the electronic circuitry from an outside resource typically through a cellular or other electronic connection to that circuit.

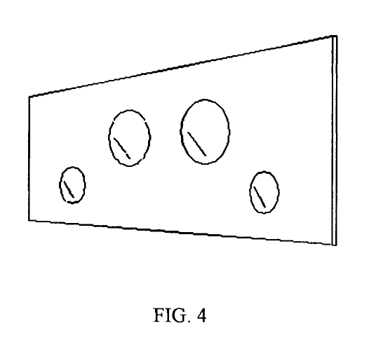

Referring now to the invention in more detail, in FIG. 3 and FIG. 4 there is a top view and perspective view of a typical Liquid Crystal Display or Plasma Screen Display that is thin enough to fit behind the bezel of the instrument panel, facing the driver of the vehicle. The display panel is overlaid by a bezel that protects the edges of the display screen from damage and creates a stylish appearance to the overall interface.

The construction details of the invention as shown in FIG. 1 through FIG. 4 are that the Liquid Crystal Display or the Plasma Screen Display is placed behind the instrument panel bezel, so that the edges of the Display are hidden behind the bezel like a picture frame would trim out a painting or a photograph. Those familiar with the art would recognize the materials as ABS plastic or some blend of various polymers to make the bezel, the screen, and the supporting framework.

A feature of the construction is the modularity of the entire display, with the exception of the power supply, which is provided by the batteries and charging system of the vehicle. Still another critical feature of the construction is the Computer Processing Unit (CPU) that is integral to the display module. This unit is programmable and can be utilized to facilitate the adjustment and display of operator-specific performance characteristics for the acceleration rate, top speed, and electronic braking performance of the vehicle. The CPU is encryption-capable to protect the settings from tampering by an unauthorized operator.

Still another feature of the construction is the communications interface, be it cellular, radio, or other form of electronic communication between the Display Unit CPU and an outside source of electronic information. This physically facilitates the downloading of visual message information and allows uploading of other data from the vehicle to the central database for the purpose of diagnostics, statistical analysis, and reporting.

The advantages of the present invention include, without limitation, the adaptability of the vehicle to specific performance requirements such as speed limitations, acceleration limitations, towing performance, messaging to the operator prior to moving the vehicle, and alert messages that can be sent to the vehicle and displayed on the instrument panel through wireless or other electronic means.

Those familiar with the art of automobile instrumental displays, and more particularly digital displays such as graphical user interfaces, will agree that the addition of downloaded current information such as advertisements, weather alerts, or factory messages to the vehicle operator during the booting period of time before the vehicle is energized for movement is valuable, unique and novel. The present invention allows the vehicle operator to be accessed by outside resources while the display is energized in such a manner that it is not particularly distracting the operator, or at such times that the operator's attention on the display is not hazardous to the operation of the vehicle.

In broad embodiment, the present invention is the creation of a new communication medium through which information can be directed to the operator from the factory, or its assigns, in a nearly real time, or real time, basis. This access is as unique and novel in the automotive industry as the “smart” cell phone was to the personal cell phone communication industry. Those familiar with the art know that there are currently subscription services whereby audio communication can be requested by the operator with an outside resource. There are currently no such services, by subscription or otherwise, that provide a visual graphical communication with the operator from an outside resource.

In an embodiment of the present invention, the invention may be termed “Twitter for Cars.” An embodiment comprises an automobile instrument display comprising electronic hardware and/or software as necessary to display an electronic image or text message other than typical automotive indicating instruments, including alerts, advertisements, messages, graphics, or other electronic information.

In another embodiment, the present invention comprises an automobile-based electronic receiver and display that allows graphic or text information to be received and displayed to the operator of an automobile.

In another embodiment, the present invention comprises a wireless, cellular phone, radio, or other electronic means of receiving and displaying to an operator of an automobile downloaded information which is downloaded from an outside electronic source.

In another embodiment, the present invention comprises a data output device capable of displaying to the operator of an automobile any sort of scalable electronic information which may be downloaded into or transmitted to the automobile.

In another embodiment, the present invention comprises a method of transmitting a communication wirelessly between an automobile and an outside location via electronic means that may receive or transmit information between the automobile and that outside source, including the display of that information on a graphical user interface that is comprised of hardware and software in such as fashion as to be viewable by the operator seated in the seat of that automobile.

In another embodiment, the present invention comprises a method of communicating a video stream or stored file that consists of commercials, directions, notifications, or other information visually to the driver of a vehicle on a screen which is located in place of certain of some or any of the vehicle's instruments on the instrument panel which are required for normal vehicle operation.

In another embodiment, the present invention comprises a method of transmitting the status of the commercial activity of the vehicle to the vehicle, in which the status may be displayed on the screen as a value-added feature for commercial fleets. For example, a parts delivery truck may be on a route and parked at a particular location with the driver outside the vehicle. When the driver returns to the vehicle and turns the key to the ON position, a status update message may be graphically displayed for the driver to proceed to new location to pick up parts from a customer for machine work at the shop. There is now a time-stamped direction in place to direct the driver to follow the new route modifications. Those familiar with the art know that sometimes smart phones are a liability for drivers; therefore, the proposed improvement is a notice that is given before the vehicle is placed in motion. Still further, the fleet manager may not have a better time to make the notification, so the vehicle holds the notification until the moment before the vehicle is placed in motion. A touch screen allows the drive to acknowledge the notification before the vehicle is placed in motion.

In another embodiment, the present invention comprises a method of communication commercial information to the driver of a vehicle by utilizing the period of time after the vehicle is stopped and parked to notify the driver via electronic download. This may include a commercial advertisement “spot” that may be sold to interested parties who wish to contact the occupants of the vehicle after it is stopped and parked. For example, the vehicle is stopped and parked at 5PM, and a local restaurant has bought a commercial spot on the vehicle's memory. A commercial runs for a few seconds informing the driver that if they stop by with some special token, such as a designated key fob, they can get a discount for supper. The suggestion is often acted upon if made at the right time of day. This is an improvement over the current art, which is to utilize smart phones for such commercial notifications. These notifications may be read while the vehicle is being operated, which is dangerous to the driver, the vehicle, and the surroundings. The proposed invention solves those safety issues by only performing the notification while the vehicle is stopped and parked.

Another embodiment of the present invention comprises utilizing a video message with sound to communicate a message to the driver of a vehicle. Those familiar with the art will appreciate that a video message with sound is more effective at communicating a message than a text message. The proposed invention utilizes a motion picture message that may incorporate printed words, but more preferably utilizes a combination of sound and printed information, and even more preferably utilizes pictures or moving pictures to convey the message. The proposed invention utilizes a portion or the entire instrument display in carrying the message from the remote sender to the driver.

Further, there are services where the automobile may be unlocked remotely by electronic means through a phone call to the service provider. It is, however, a significant improvement to the art to provide a visual graphical interface between a service provider and the operator of the vehicle.

Still further, the applications of this new medium may be too numerous to fully describe in this application, but the general methodology of contact with the operator is unique and novel to the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. Moreover, the terms “consisting”, “comprising” and other derivatives from the term “comprise” are intended to be open-ended terms that specify the presence of any stated features, elements, steps, or components, and are not intended to preclude the presence or addition of one or more other features, elements, integers, steps, components, or groups thereof. Moreover, Applicants have endeavored in the present specification and drawings to draw attention to certain features of the invention, it should be understood that the Applicant claims protection in respect to any patentable feature or combination of features referred to in the specification or drawings. The drawings are provided to illustrate features of the invention, but the claimed invention is expressly not limited to the illustrated embodiments.

I claim:

1. An automobile instrument display comprised of electronic hardware and software, said display comprising a graphical user interface,
wherein said graphical user interface comprises a screen, said screen being located in place of at least one of an instrument on an instrument panel of a vehicle which is required for normal vehicle operation, and
wherein said graphical user interface can display an electronic image or text message other than typical automotive indicating instruments, including alerts, advertisements, messages, graphics, or other electronic information.

2. An automobile-based electronic receiver and display that allows graphic or text information to be received and displayed to the operator of an automobile.

3. The electronic receiver and full motion video display of claim 2, wherein said information is downloaded information which is downloaded from an outside electronic source.

4. The electronic receiver and full motion video display of claim 2, wherein the method of receiving and displaying information comprises wireless, cellular telephone, radio, or other electronic methods.

5. An automobile-based data output device having a display capable of displaying to the operator of said automobile scalable full motion video electronic information, wherein said scalable electronic information is downloaded into or transmitted to the automobile.

6. A method of transmitting a communicating wirelessly between an automobile and an outside location via electronic means, said method comprising:
(1) transmitting information from said outside source to said automobile:
(2) receiving said information at said automobile; and
(3) displaying said information on a graphical user interface.

7. The method of claim 6, wherein said graphical user interface comprises hardware and software in such as fashion as to be viewable by an operator seated in the seat of said automobile.

8. A method of communicating a video stream or stored file comprising commercials, directions, notifications, or other information visually to a driver of a vehicle, wherein said video stream or stored file is displayed on a screen,
wherein said screen is located in place of at least one of an instrument on an instrument panel of a vehicle which is required for normal vehicle operation.

9. A method of transmitting the status update of the commercial activity of a vehicle to said vehicle from an outside source, wherein said status is displayed on a screen viewable in said vehicle.

10. The method of claim 9, wherein said status of the commercial activity is updated when the vehicle is parked with a starting key in an OFF position, and wherein said status of the commercial activity is graphically displayed for a driver after the starting key is in an ON position.

11. The method of claim 9, wherein said status update is displayed only at a moment before said vehicle is placed in motion.

12. The method of claim 9, wherein a driver acknowledges the status update by engaging a touch screen before the vehicle is placed in motion.

13. A method of communication of commercial information to a driver of a vehicle, said method comprised of delivering an electronically downloaded video message to said driver in a period of time after the vehicle is stopped and parked.

14. A method of communicating a video message with sound to a driver of a vehicle, wherein said video message is displayed on a screen located in place of at least one of an instrument on an instrument panel of a vehicle which is required for normal vehicle operation.
